(19) United States
(12) Patent Application Publication
(10) Pub. No.: US 2015/0193015 A1
(43) Pub. Date: Jul. 9, 2015

(54) Computer Interaction Device

(71) Applicant: Nineren Kang, Diamond Bar, CA (US)

(72) Inventor: Nineren Kang, Diamond Bar, CA (US)

(21) Appl. No.: 14/588,972

(22) Filed: Jan. 4, 2015

Related U.S. Application Data
(60) Provisional application No. 61/923,721, filed on Jan. 5, 2014.

(51) Int. Cl. G06F 3/03

(52) U.S. Cl. CPC G06F 3/0312

(57) ABSTRACT

A computer mouse is presented with added capabilities and circuitry to access features, such as touch screen features, of newer computer operating systems.

### CROSS-REFERENCE TO RELATED APPLICATION

This application claims priority from U.S. Provisional Patent Application Ser. No. 61/923,721, filed on 5 Jan. 2014, incorporated herein by reference in its entirety.

### FIELD OF THE INVENTION

The invention pertains to computer mice with adaptations for use with new operating systems while remaining compatible with older operating systems.

### BACKGROUND OF THE INVENTION

The advent of the personal computer industry brought with it the need for pointing devices, such as mice, which have been improved over the years to provide advanced functionality and features. For example, variations have included the number of push buttons provided to the users and software designers, or the inclusion of a scroll wheel to allow control of the computer screen.

With the introduction of new computer operating systems, such as Windows 8, comes the need for improved mice to access new operating system features. This need is, in part, due to the integration of features designed for touch screen users. For example, the new Windows “Charm” feature and the new application toggle cannot be accessed by a now-standard mouse. The inability to access these two core features of the new software via a mouse requires the user to repeatedly abandon the mouse to use the keyboard, or to reach over to touch the screen. In many cases, a user working at a desk will not be within easy reach of the screen, and would have to interrupt the flow of work to move to reach it.

Additionally, it is desirable to provide additional mouse-based controls to efficiently work with the new or improved features of newer software. One such example is providing a mouse with the ability to itself control the size of objects on the screen, that is, to provide a zoom control from the mouse. Another desirable feature is providing a selectively functioning second position sensor on the mouse which, when turned on, will allow the user to simulate two-finger gestures on a touch screen, for example, sliding, swiping, or rotating an image.

Further, due to the increased capabilities of voice recognition software, it is desirable to provide a mouse with a selectively usable microphone, so that the microphone is always at hand but in operation only when needed.

Finally, due to differences between the two major personal computer types (PC and MAC), it is desirable to provide a mouse that may be toggled between PC and MAC mode, where the features provided by the mouse change as appropriate to the operating system in use.

### SUMMARY OF THE INVENTION

The invention is a computer mouse with an additional button (functionality control button), preferably mounted on the side of the mouse, and convenient to the location where the user's fingers would normally rest. This button may be used to toggle on or off one or more added functions of the mouse, depending on the user's preference. Depending on the particular embodiment of the mouse and the application, the functionality control button may be a press-and-hold for “on” button, or may be a switch-on-switch-off toggle button.

In one embodiment of the invention, with the functionality control button turned on, the user may use the scroll wheel to zoom in or out, for example, changing the screen size of text, photos, or icons.

In a further embodiment, the mouse may be equipped with two functionality control buttons, for example, one on either side of the mouse, which may provide either the same or different functions, depending on the desired overall functionality of the mouse. Further, the functionality control button (or each functionality control button, if there is more than one) may provide different functionality depending on the type of operating system the mouse is being used with.

In another embodiment of the invention, the mouse is provided with two additional switch buttons, mounted on the mouse circuit board. The mouse scroll wheel may be tilted slightly to one side or the other to engage one of the buttons. These buttons may be used to access the Windows 8 Charm feature and the Application Toggle, respectively, or, with a MAC system, special features applicable to the Apple operating system, such as page forward and backward. This embodiment also provides a customized integrated circuit (IC) that provides for the additional switch connections, and, by providing the necessary signal control, avoids the need to provide a microcontroller within the mouse itself. Alternatively, a microcontroller with customized firmware may be used.

Those of skill in the art will recognize that certain features of this embodiment of the invention are flexible. For example, the choice of which switch activates which Windows feature may vary by the country in which the mouse is expected to be used. Additionally, the addition of this added functionality to a mouse does not preclude it from being backward-compatible with older operating systems.

A further embodiment of the invention provides a PC/MAC selector switch on the printed circuit (PC) board hosting the controller IC, or integrated with a microcontroller. Such a switch provides a toggle, and the IC may be designed so that the output of the mouse upon activation of added features (such as bottom switches) will differ depending on whether the mouse is being used with a PC system or a MAC system.

In another embodiment of the invention, the mouse is provided with a second sensor, such as an optical or laser sensor, offset from the primary position sensor of the mouse. With the second sensor activated by the functionality control button, the user may simulate two-finger controls on a touch screen. For example, the user may simulate linear two-finger motions to control horizontal or vertical scrolling of the screen (or of an object thereon), or may rotate the mouse to rotate an image on the screen. Additionally, the rate of either linear or rotational motion may be translated logarithmically to represent acceleration to the computer operating system. For example, a steady speed might be used to communicate a “slide” operation to Windows 8, and an accelerated speed might be used to communicate a “swipe” to Windows 8. Some features, such as sliding or swiping, may also be accomplished using only one position sensor.

The positioning of the two sensors is preferably correlated in essentially the same relative position as the tips of a person's index and middle fingers, so that the user's hand motion with the mouse can naturally follow the motions the user would make on a touch screen.

Another embodiment of the invention provides a microphone to provide the user with a convenient input when using applications that offer voice recognition, or other applications providing for audio input. In this embodiment, the microphone may be selectively activated, either via the functionality control button, or by providing a gyro switch so that the microphone may be turned on or off by changing the position of the mouse. This microphone is preferably set into the mouse body sufficiently deep to reduce ambient noise, reducing the need to provide a high-quality microphone for this input.

### BRIEF DESCRIPTION OF THE DRAWINGS

FIG. 1A is a side view of an embodiment of a computer mouse of the present invention.

FIG. 1B is a bottom view of the embodiment of FIG. 1A.

FIG. 2 is a bottom view of an alternative embodiment of the mouse of FIG. 1A.

FIG. 3 is a perspective view of an alternative embodiment of the mouse of FIG. 1A.

FIG. 4 is a schematic representation of a printed circuit board and its connections to mouse components for use with the present invention.

FIG. 5 is an example flow diagram reflecting possible functional flows by utilizing an embodiment of the present invention.

### DETAILED DESCRIPTION

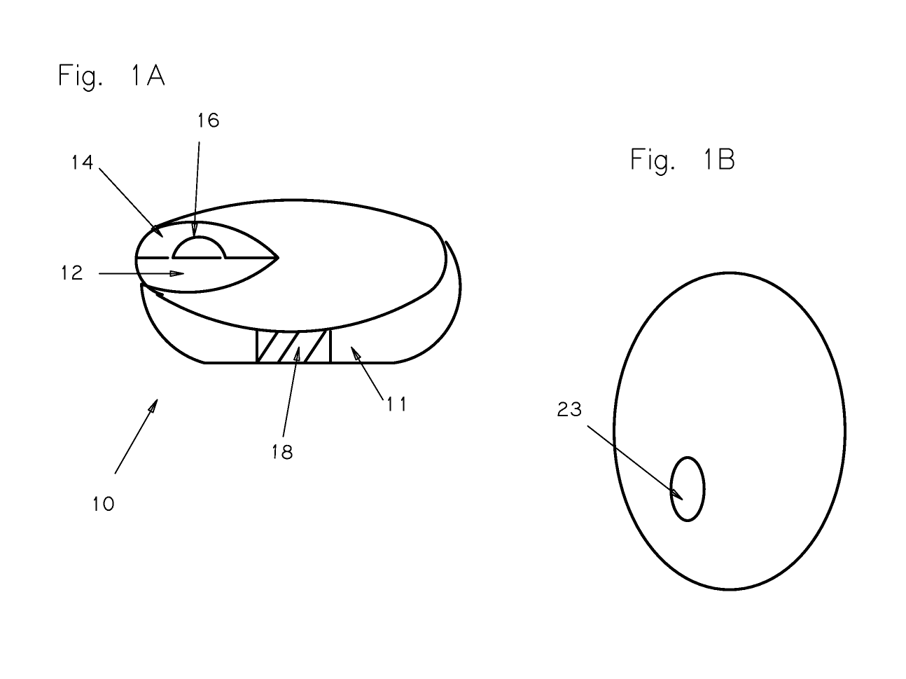

Referring to FIG. 1A, mouse 10 is shown with left mouse button 12, right mouse button 14, and scroll wheel 16. A middle mouse button (not shown) is preferably provide underneath scroll wheel 16, so that depressing scroll wheel 16 activates the middle mouse button when the mouse is attached to a PC, but may provide different functionality on a MAC. Functionality control button 18 is placed on the side 11 of mouse 10 in a position where the user's fingers will normally rest with easy access to functionality control button 18. The mouse may be provided with a second functionality control button (not shown), placed on the other side of the mouse, or a single functionality control button may be placed on either side of the mouse to accommodate left-handed or right-handed users.

Referring to FIG. 1B, a bottom view of one embodiment of mouse 10 of FIG. 1A is shown. Present on the bottom of the mouse is optical or laser sensor 23.

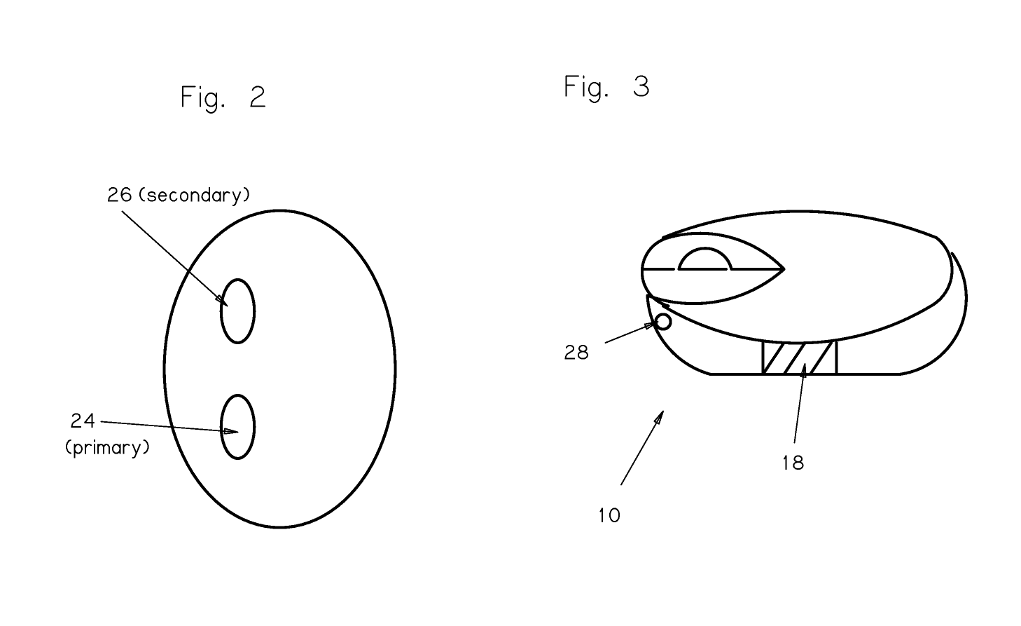

Referring to FIG. 2, the bottom view of an alternative embodiment of the mouse 10 of FIG. 1A is shown. In addition to primary optical or laser sensor 24, a secondary optical or laser sensor 26 is provided. When the functionality control button is activated, secondary optical or laser sensor 26 is activated as well, and with two points of reference the mouse may be used to simulate functions that the user could access with a two finger motion on a touch screen. For example, the user may use the mouse to effect left to right or up to down scrolling, or rotate an image on the screen. Some features, such as sliding or swiping, may also be accomplished using only one position sensor.

Referring to FIG. 3, another alternative embodiment of mouse 10 is shown. In this embodiment, mouse 10 is provided with microphone 28 to provide the user with a handy and easily accessible microphone. Microphone 28 may be activated by engaging functionality control button 18, or by other means. For example, mouse 10 could be provided with a gyro switch (not shown) and configured so that microphone 28 would be activated when the mouse is held in a vertical position (relative to its normal horizontal position). Such configuration choices will be recognized by those skilled in the art as a matter of engineering choice only.

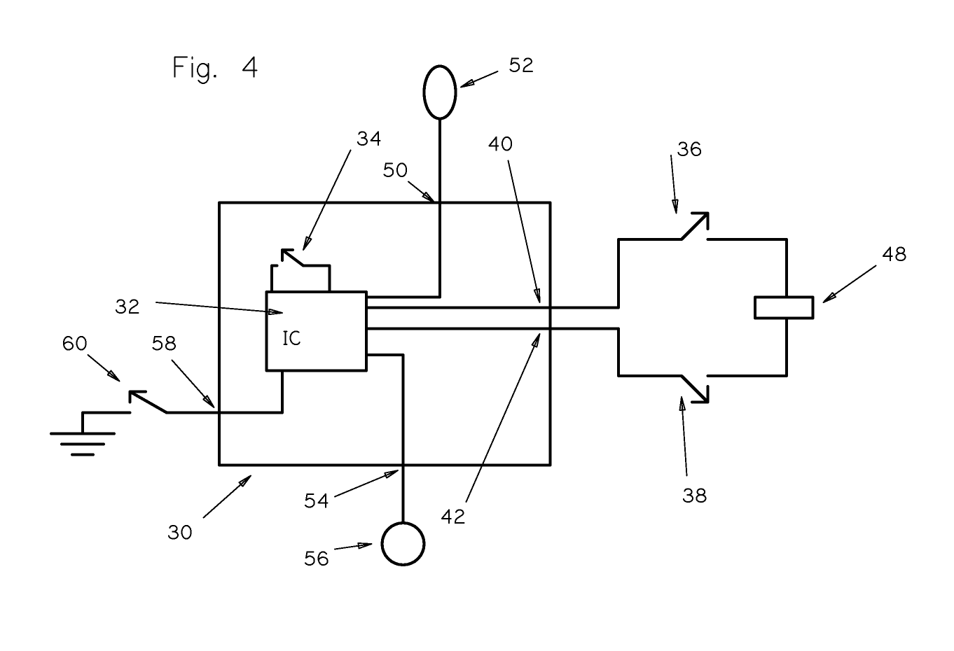

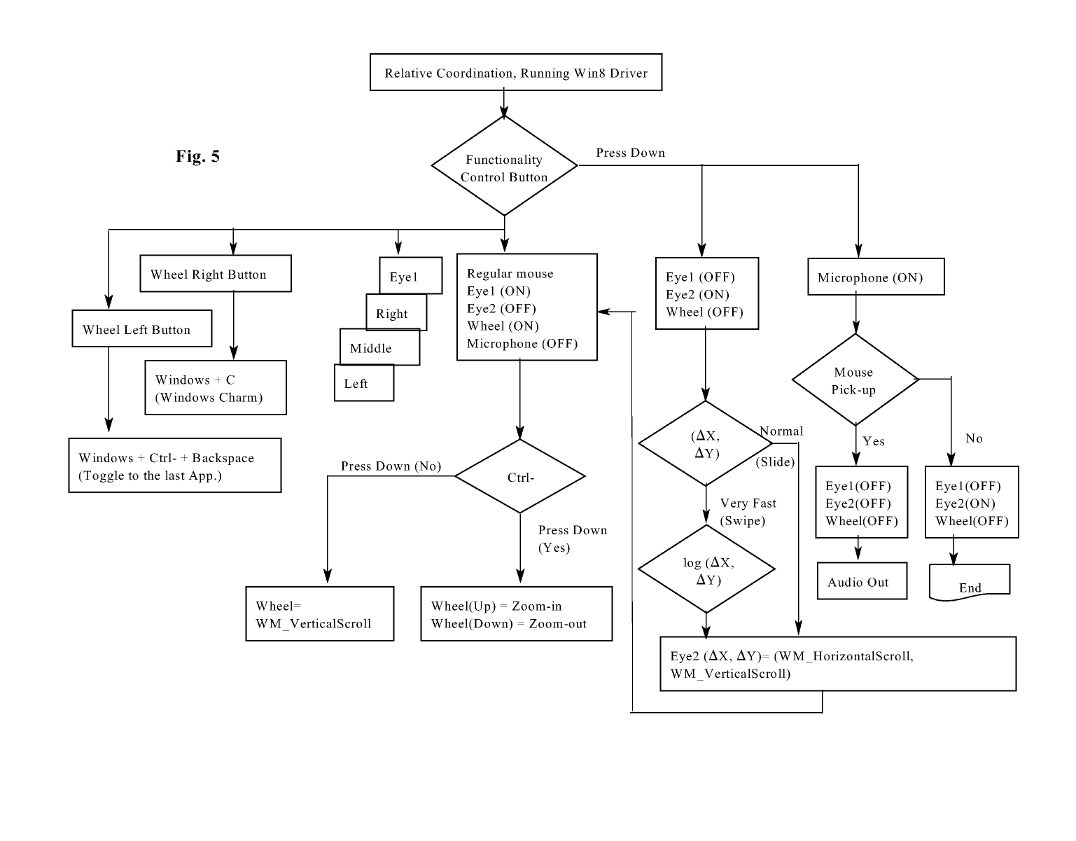

Referring to FIG. 4, printed circuit board 30 is shown schematically together with its connections to the various elements discussed above. Printed circuit board 30 comprises integrated circuit 32 and mode switch 34. Mode switch 34 may be used to set integrated circuit 32 into two or more modes, for example, allowing the user to select between PC or MAC functions. Printed circuit board 30 also comprises first connection 40 and second connection 42 to left switch 36 and right switch 38. Left switch 36 and right switch 38 may be selectively activated by tilting scroll wheel 48 to the right or the left to activate the functionality assigned to that switch.

Printed circuit board 30 may also comprise third connection 58 linking it to functionality control button 60, fourth connection 50 linking it to secondary optical or laser sensor 52, and fifth connection 54 linking it to microphone 56.

Referring to FIG. 5, one possible description of the logic flow to support the functionality of a mouse of the present invention is shown. In the case of FIG. 5, the logic shown supports a Windows mouse and accesses Windows 8 features.

Those of skill in the art that the individual components shown may be used in one or more combinations without departing from the spirit of the invention. It will be further understood that integrated circuit 32 must have a connection (not shown) to a computer (also not shown), but those of skill in the art will recognize that the means for making such a connection, whether wired or wireless, are well known and well understood.

I claim:

1. A mouse comprising a body having substantially vertical sides for use with a computer system, said mouse comprising
a first functionality control button on one of said sides of said mouse.

2. The device of claim 1, wherein said mouse additionally comprises a second functionality control button.

3. The device of claim 1, wherein said first functionality control button is in signal communication with the computer system.

4. The device of claim 2 wherein said second functionality control button is in signal communication with the computer system.

5. The device of claim 3 wherein said first functionality control button is in signal communication with the computer system via an integrated circuit.

6. The device of claim 4, wherein said second functionality control button is in signal communication with the computer system via an integrated circuit.

7. The device of claim 1, wherein said mouse comprises a bottom, and wherein said bottom comprises a first optical sensor in signal communication with the computer system, and a second optical sensor.

8. The device of claim 7, wherein said second optical sensor is in signal communication with the computer system when said first functionality button is pressed.

9. The device of claim 2, wherein said mouse comprises a bottom, and wherein said bottom comprises a first optical sensor in signal communication with the computer system, and a second optical sensor.

10. The device of claim 9, wherein said second optical sensor is in signal communication with the computer system when said second functionality button is pressed.

11. The device of claim 1, wherein said mouse additionally comprises a microphone.

12. The device of claim 2, wherein said mouse additionally comprises a microphone.

13. The device of claim 11, wherein said mouse comprises a bottom, and wherein said microphone is in signal communication with the computer system when said bottom is rotated to an essentially vertical orientation.

14. The device of claim 11, wherein said microphone is in signal communication with the computer system when said first functionality control button is pressed.

15. The device of claim 12, wherein said mouse comprises a bottom, and wherein said microphone is in signal communication with the computer system when said bottom is rotated to an essentially vertical orientation.

16. The device of claim 12, wherein said microphone is in signal communication with the computer system when said second functionality control button is pressed.

17. The device of claim 1, wherein said mouse comprises a tiltable scroll wheel and a first selector switch and a second selector switch proximate said scroll wheel, and wherein said first selector switch is in signal communication with the computer system when said scroll wheel is titled in one direction and said second selector switch is in signal communication with the computer system when said scroll wheel is titled in the opposite direction.

18. The device of claim 3 wherein said first functionality control button is in signal communication with the computer system via firmware.

19. The device of claim 11, wherein said microphone is in signal communication with the computer system when said first functionality control button is depressed.
